(19) United States
(12) Patent Application Publication
(10) Pub. No.: US 2025/0199363 A1
(43) Pub. Date: Jun. 19, 2025

(54) LIQUID CRYSTAL DISPLAY PANEL

(71) Applicant: Guangzhou China Star Optoelectronics Semiconductor Display Technology Co., LTd., Guangzhou (CN)

(72) Inventor: Haosen SHI, Guangzhou (CN)

(73) Assignee: Guangzhou China Star Optoelectronics Semiconductor Display Technology Co., LTd., Guangzhou (CN)

(21) Appl. No.: 19/067,474

(22) Filed: Feb. 28, 2025

Related U.S. Application Data
(63) Continuation of application No. PCT/CN2023/128219, filed on Oct. 31, 2023.

(30) Foreign Application Priority Data
Apr. 19, 2023 (CN) 202310423749.6

(51) Int. Cl. G02F 1/1337; G02F 1/1343; G02F 1/1362

(52) U.S. Cl. CPC G02F 1/133707; G02F 1/134309; G02F 1/136286

(57) ABSTRACT

A liquid crystal display panel includes an array substrate which includes a substrate, a first electrode layer, an insulating layer and a second electrode layer. The first electrode layer is disposed on the substrate, and includes a base layer and protrusions arranged at intervals on a side of the base layer away from the substrate. The insulating layer is disposed between the first electrode layer and the second electrode layer. The second electrode layer includes branch electrodes and hollow portions each disposed opposite to one of the protrusions. An orthographic projection of a middle portion of each of the protrusions on the substrate overlaps an orthographic projection of one of the hollow portions on the substrate, and an orthographic projection of an edge portion of the protrusion on the substrate partially overlaps an orthographic projection of one of the branch electrodes on the substrate.

### CROSS-REFERENCE TO RELATED APPLICATIONS

This application is a continuation of International Application No. PCT/CN2023/128219, filed on Oct. 31, 2023, which claims priority to Chinese Patent Application No. 202310423749.6, filed on Apr. 19, 2023. The disclosures of the abovementioned applications are incorporated herein by reference in their entireties.

### TECHNICAL FIELD

The present application relates to display technologies, and in particular to a liquid crystal display (LCD) panel.

### BACKGROUND

In an LCD panel using the fringe electric field drive mode, a pixel electrode and a common electrode are not in the same plane and are separated by an insulating layer. Although the LCD panel using the fringe electric field drive mode has characteristics such as wide viewing angle, it has a lower light transmittance than an LCD panel using the vertical electric field drive. In the traditional pixel process design, the entire pixel electrode has an uniform height, and the common electrode has a slope angle of 90 degrees. Thus, the liquid crystal molecules in different regions have different perceptions of the fringe electric field and different degrees of deflection, which in turn affects the light transmittance of the entire panel.

### SUMMARY

According to one or more embodiments of the present application, a liquid crystal display panel includes an array substrate. The array substrate includes a substrate, a first electrode layer, an insulating layer, and a second electrode layer. The first electrode layer is disposed on the substrate, and includes a base layer and a plurality of protrusions arranged at intervals on a side of the base layer away from the substrate. The insulating layer is disposed on the substrate and covers the first electrode layer. The second electrode layer is disposed on the insulating layer, and includes a plurality of hollow portions and a plurality of branch electrodes. Each of the hollow portions is disposed between two of the branch electrodes and opposite to one of the protrusions. The second electrode layer and the first electrode layer are configured to form an electric field. Each of the protrusions comprises a first middle portion and a first edge portion located at a periphery of the first middle portion. An orthographic projection of the first middle portion on the substrate overlaps an orthographic projection of one of the hollow portions on the substrate, and an orthographic projection of the first edge portion on the substrate partially overlaps an orthographic projection of one of the branch electrodes on the substrate.

### BRIEF DESCRIPTION OF THE DRAWINGS

FIG. 1 schematically shows a structure of a liquid crystal display panel according to one or more embodiments of the present application.

FIG. 2 schematically shows an example structure of part A in FIG. 1.

FIG. 3 schematically shows another example structure of part A in FIG. 1.

### DETAILED DESCRIPTION

Some embodiments of the present application will be described in detail below with reference to the accompanying drawings. The embodiments are described for illustrative purposes only and are not intended to limit the present application.

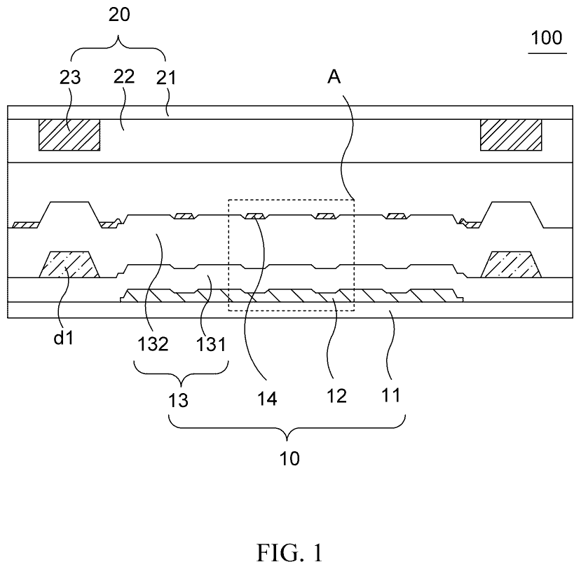

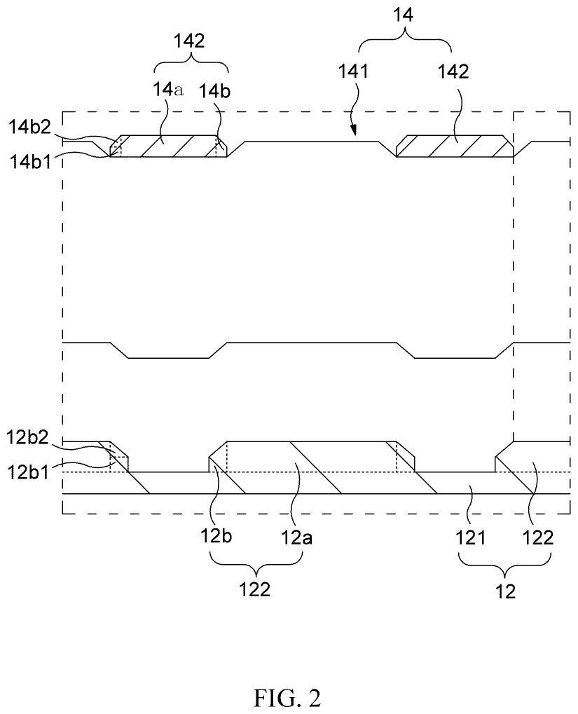

As shown in FIG. 1 and FIG. 2, a liquid crystal display panel 100 according to one or more embodiments of the present application includes an array substrate 10. The array substrate 10 includes a substrate 11, a first electrode layer 12, an insulating layer 13, and a second electrode layer 14.

The first electrode layer 12 is disposed on the substrate 11. The first electrode layer 12 includes a base layer 121 and a protrusion 122, and the protrusion 122 is disposed on the side of the base layer 121 away from the substrate. The insulating layer 13 is disposed on the substrate 11 and covers the first electrode layer 12. The second electrode layer 14 is disposed on the insulating layer 13, and the second electrode layer 14 and the first electrode layer 12 are used to form an electric field. The second electrode layer 14 includes a hollow portion 141 and a branch electrode 142, and the hollow portion 141 is disposed corresponding to the protrusion 122. Among them, in the direction of the orthographic projection of the substrate 11, the orthographic projection of the middle portion of the protrusion 122 on the substrate 11 overlaps the orthographic projection of the hollow portion 141 on the substrate 11, and the orthographic projection of the edge part of the protrusion 122 on the substrate 11 partially overlaps the orthographic projection of the branch electrode 142 on the substrate 11.

In some embodiments of the present application, the first electrode layer 12 further includes another protrusion 122, and the two protrusions 122 are arrange at interval with each other.

In some embodiments of the present application, the second electrode layer 14 further includes another branch electrode 142, and the hollow portion 141 is disposed between the two branch electrodes 142.

In the liquid crystal display panel 100 according to one or more embodiments of the present application, the protrusion 122 of the first electrode layer 12 is disposed corresponding to the hollow portion 141 of the second electrode layer 14, and the orthographic projection of the edge portion of the protrusion 122 on the substrate 11 partially overlaps the orthographic projection of the branch electrode 142 on the substrate 11.

It can be understood that, in the prior art, the electric field strength in the region of the branch electrode is greater than the electric field strength in the region of the hollow portion region. Therefore, the protrusion 122 is adopted in the embodiment of the present application, the distance between the first electrode layer 12 and the region of the hollow portion 141 is reduced, thereby increase the electric field strength in the region of the hollow portion 141. The orthographic projection of the edge portion of the protrusion 122 on the substrate 11 partially overlaps the orthographic projection of the branch electrode 142 on the substrate 11, so that the electric field strength in the region of the branch electrode 142 transitions evenly to the electric field strength in the region of the hollow portion 141, thereby making the electric field strengths in the region of the branch electrode 142 and the hollow portion 141 tend to be consistent, reducing the potential difference between different regions of the second electrode layer 14, thereby improving the light transmittance of the liquid crystal display panel 100.

Optionally, the materials of the first electrode layer 12 and the second electrode layer 14 are both transparent conductive materials, such as indium tin oxide, indium zinc oxide, etc.

Optionally, as shown in FIG. 2, the branch electrode 142 includes a second middle portion 14a and a second edge portion 14b, and the second edge portion 14b is located at a periphery of the second middle portion 14a. The orthographic projection of the second edge portion 14b on the substrate 11 partially overlaps the orthographic projection of the protrusion 122 on the substrate 11. The thickness of the second edge portion 14b gradually increases in a direction from the edge of the branch electrode 142 toward the centre of the branch electrode 142.

In this embodiment of the present application, the thickness of the second edge portion 14b is gradually changed so that the electric field strength in the region of the second middle portion 14a of the branch electrode 142 transitions evenly to the electric field strength in the region of the hollow portion 141, which makes the electric field distribution in the region of the second electrode layer 14 more uniform.

Optionally, in a direction from the edge of the branch electrode 142 to the centre of the branch electrode 142, the thickness of the second middle portion 14a is uniform and is equal to the maximum thickness of the second edge portion 14b.

This embodiment adopts a second middle portion 14a with uniform thickness. The surface of the second middle portion 14a is flat, which facilitates the liquid crystal deflection to be uniform.

Optionally, the second edge portion 14b includes a second bottom sub-portion 14b1 and a second transition sub-portion 14b2, and the second bottom sub-portion 14b1 is disposed on the insulating layer 13. The second transition sub-portion 14b2 is disposed on the second bottom sub-portion 14b1. In a direction from the edge of the branch electrode 142 to the centre of the branch electrode 142, the thickness of the second transition sub-portion 14b2 increases gradually, and the thickness of the second bottom sub-portion 14b1 is arranged uniformly. The slope angle of the first gradual sub-portion 14b2 is less than 90 degrees.

Optionally, the slope angle of the first gradual sub-portion 14b2 may be 15 degrees, 30 degrees, 45 degrees, 60 degrees, 75 degrees, etc.

Optionally, the protrusion 122 includes a first middle portion 12a and a first edge portion 12b, and the first edge portion 12b is located at a periphery of the first middle portion 12a. The orthographic projection of the first edge portion 12b on the substrate 11 at least partially overlaps the orthographic projection of the second edge portion 14b on the substrate 11. The thickness of the first edge portion 12b gradually increases from the edge of the protrusion 122 toward the centre of the protrusion 122.

In this embodiment of the present application, the thickness of the first edge portion 12b is gradually changed, so that the distance from the surface of the first edge portion 12b to the second electrode layer 14 changes gradually in the opposite trend, the electric field strength in the region of the second middle portion 14a of the branch electrode 142 transitions evenly to the electric field strength in the region of the hollow portion 141, and the electric field distribution in the region of the second electrode layer 14 is more uniform.

Optionally, in a direction from the edge of the protrusion 122 toward the centre of the protrusion 122, the thickness of the first middle portion 12a is uniform and is equal to the maximum thickness of the first edge portion 12b.

In this embodiment of the present application, the first middle portion 12a with uniform thickness corresponds to the hollow portion 141, so that the region of the hollow portion 141 is flat corresponding to the surface of the insulating layer 13, which facilitates uniform deflection of the liquid crystal.

Optionally, the first edge portion 12b includes a first bottom sub-portion 12b1 and a first transition sub-portion 12b2, and the first bottom sub-portion 12b1 is disposed on the substrate 11. The first transition sub-portion 12b2 is disposed on the first bottom sub-portion 12b1. In the direction from the edge of the protrusion 122 to the centre of the protrusion 122, the thickness of the first transition sub-portion 12b2 increases gradually, and the thickness of the first bottom sub-portion 12b1 is uniform. The slope angle of the second gradual sub-portion 12b2 is less than 90 degrees.

Optionally, the slope angle of the first transition sub-portion 12b2 may be 15 degrees, 30 degrees, 45 degrees, 60 degrees, 75 degrees, etc.

Among them, the first bottom sub-portion 12b1 raises the first transition sub-portion 12b2, so that the lowest point of the upper surface of the first edge portion 12b is closer to the second electrode layer 14, reducing the step difference between the minimum thickness and the maximum thickness of the first edge portion 12b, thereby achieving the effect of further homogenizing the electric field.

Optionally, the slope angle of the second gradual sub-portion 12b2 is 45 degrees. When the slope angle of the second gradual sub-portion 12b2 is 45 degrees, the homogenization effect of the electric field is better.

Optionally, the thickness of the first bottom sub-portion 12b1 is greater than the thickness of the second bottom sub-portion 14b1. The thickness of the second middle portion 14a is equal to the maximum thickness of the second edge portion 14b, and the thickness of the first middle portion 12a is equal to the maximum thickness of the first edge portion 12b. Therefore, the greater the thickness of the second bottom sub-portion 14b1 is, that is, the greater the thickness of the branch electrode 142 is, the greater the influence on the alignment of the liquid crystal gets, so the branch electrode 142 with a smaller thickness can improve the consistency of the liquid crystal alignment; and the higher the first bottom sub-portion 12b1 is, that is, the greater the thickness of the protrusion 122 is, the smaller the distance between the protrusion 122 and the hollow portion 141 of the second electrode layer 14 gets, which can enhance the strength of the corresponding electric field; that is, the consistency of liquid crystal deflection can be balanced by adjusting the thickness difference between the second bottom sub-portion 14b1 and the first bottom sub-portion 12b1.

Optionally, the width of the branch electrode 142 is smaller than the width of the hollow portion 141 and the width of the protrusion 122.

It can be understood that in the prior art, the width of the branch electrode is larger, while the width of the hollow portion is smaller, so that the electric field in region of the branch electrode is stronger. This embodiment balances the electric field strength of the two regions by reducing the width of the branch electrode 142 and increasing the widths of the hollow portion 141 and the protrusion 122 corresponding to the hollow portion 141.

Optionally, the first electrode layer 12 is one of a pixel electrode and a common electrode, and the second electrode layer 14 is the other one of the pixel electrode and the common electrode.

Optionally, the array substrate 10 further includes a gate, an active layer, a source, a drain and a data line d1. The insulating layer 13 includes a first insulating sublayer 131 and a second insulating sublayer 132. The gate is disposed on the substrate 11. The first insulating sublayer 131 covers the first electrode layer 12. The active layer is disposed on the first insulating sublayer 131. The source is connected to one side of the active layer, and the drain is connected to the other side of the active layer. The data line d1 is disposed on the first insulating sublayer 131. The second insulating sublayer 132 covers the source, the drain and the data line d1. The second electrode layer 14 is disposed on the second insulating sublayer 132. The drain is connected to the first electrode layer 12 or the second electrode layer 14.

It should be explained that the architecture of the thin film transistor of the array substrate 10 of the present application may also be a top gate or dual gate architecture, or the source and drain of the thin film transistor may also be separated from the active layer by an insulating layer. That is, the array substrate 10 of the present application does not limit the specific structure of the thin film transistor.

Optionally, the liquid crystal display panel 100 further includes a colour filter substrate 20. It should be noted that the colour filter substrate 20 may include a base 21, a colour filter layer 22 and a black matrix 23. The black matrix 23 shields the data line d1.

In some embodiments of the present application, the colour filter substrate 20 may not include a colour filter layer. When the colour filter substrate 20 does not include a colour filter layer, the colour filter layer is integrated into the array substrate 10.

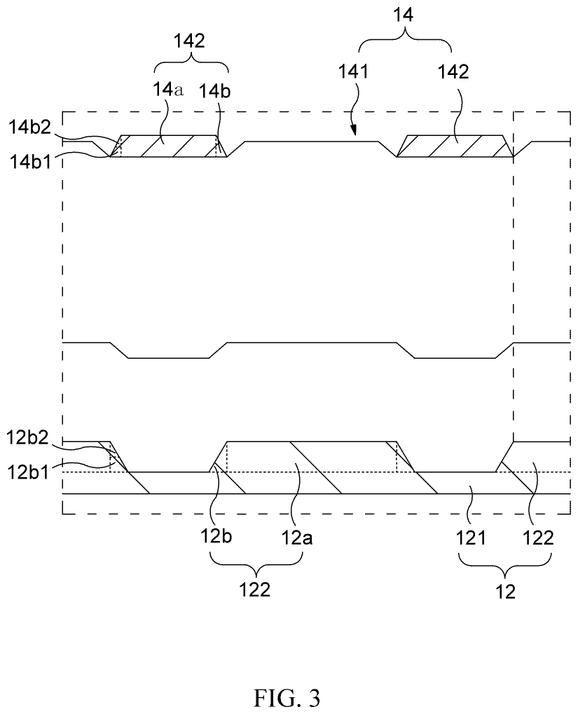

In some embodiments of the present application, as shown in FIG. 3, compared with the above embodiments, the present embodiment is different from the above embodiments in that the thicknesses of the second transition sub-portion 14b2 and the second bottom sub-portion 14b1 both increase gradually in the direction from the edge of the branch electrode 142 toward the centre of the branch electrode 142. The slope angle of the first gradual sub-portion 14b2 is consistent with the slope angle of the second bottom sub-portion 14b1 and is less than 90 degrees.

It can be understood that the side wall surface of the first gradual sub-portion 14b2 and the side wall surface of the second bottom sub-portion 14b1 are coplanar. That is, the slope angle of the second edge portion 14b is equal to the slope angles of the first gradual sub-portion 14b2 and the slope angle of the first bottom sub-portion 14b1.

Optionally, the second transition sub-portion 14b2, the second bottom sub-portion 14b1 and the second middle portion 14a are integrally formed. The slope angle of the second edge portion 14b can be 15 degrees, 30 degrees, 45 degrees, 60 degrees, 75 degrees, etc.

Optionally, in a direction from the edge of the protrusion 122 toward the centre of the protrusion 122, the thicknesses of the second gradual sub-portion 12b2 and the first bottom sub-portion 12b1 both increase gradually. The slope angle of the second gradual sub-portion 12b2 is consistent with the slope angle of the first bottom sub-portion 12b1 and is less than 90 degrees.

It can be understood that the sidewall surface of the first transition sub-portion 12b2 and the sidewall surface of the first bottom sub-portion 12b1 are coplanar. That is, the slope angle of the first edge portion 12b is equal to the slope angle of the first transition sub-portion 12b2 and the slope angle of the second bottom sub-portion 12b1.

Optionally, the first transition sub-portion 12b2, the first bottom sub-portion 12b1, the first middle portion 12a and the base layer 121 are integrally formed. The slope angle of the first edge portion 12b can be 15 degrees, 30 degrees, 45 degrees, 60 degrees, 75 degrees, etc.

In the liquid crystal display panel 100 of the embodiments of the present application, the protrusions 122 of the first electrode layer 12 are arranged corresponding to the hollow portions 141 of the second electrode layer 14, and the orthographic projection of the edge portion of the protrusion 122 on the substrate 11 is partially overlapped with the orthographic projection of the branch electrode 142 on the substrate 11.

It can be understood that, in the prior art, the electric field strength in the region of the branch electrode is greater than the electric field strength in the region of the hollow portion. Therefore, this embodiment adopts the protrusion 122, which reduces the distance between the first electrode layer 12 and the region of the hollow portion 141, thereby increasing the electric field strength in the region of the hollow portion 141. The orthographic projection of the edge portion of the protrusion 122 on the substrate 11 partially overlaps the orthographic projection of the branch electrode 142 on the substrate 11, so that the electric field strength in the region of the branch electrode 142 evenly transitions to the electric field strength in the region of the hollow portion 141, thereby making the electric field strengths in the region of the branch electrode 142 and in the region of the hollow portion 141 tend to be consistent, reducing the potential difference between different regions of the second electrode layer 14, thereby improving the light transmittance of the liquid crystal display panel 100.

Some embodiments of the present application have been described in detail above. The embodiments are described for illustrative purposes only and are not intended to limit the present application. Many modifications or equivalent substitutions with respect to the embodiments may occur to those of ordinary skill in the art based on the present application and thus shall fall within the scope of the present application defined by the appended claims.

What is claimed is:

1. A liquid crystal display panel comprising an array substrate, wherein the array substrate comprises:
a substrate;
a first electrode layer disposed on the substrate, the first electrode layer comprising a base layer and a plurality of protrusions arranged at intervals on a side of the base layer away from the substrate;
an insulating layer disposed on the substrate and covering the first electrode layer; and
a second electrode layer disposed on the insulating layer, the second electrode layer comprising a plurality of hollow portions and a plurality of branch electrodes, each of the hollow portions being disposed between two of the branch electrodes and opposite to one of the protrusions,
wherein the second electrode layer and the first electrode layer are configured to form an electric field; and
each of the protrusions comprises a first middle portion and a first edge portion located at a periphery of the first middle portion, an orthographic projection of the first middle portion on the substrate overlaps an orthographic projection of one of the hollow portions on the substrate, and an orthographic projection of the first edge portion on the substrate partially overlaps an orthographic projection of one of the branch electrodes on the substrate.

2. The liquid crystal display panel according to claim 1, wherein each of the branch electrodes comprises a second middle portion and a second edge portion located at a periphery of the second middle portion;
an orthographic projection of the second edge portion on the substrate partially overlaps an orthographic projection of one of the protrusions on the substrate; and
a thickness of the second edge portion increases gradually in a first direction from an edge of the each of the branch electrodes toward a centre of the each of the branch electrodes.

3. The liquid crystal display panel according to claim 2, wherein the orthographic projection of the first edge portion on the substrate at least partially overlaps the orthographic projection of the second edge portion of the one of the branch electrodes on the substrate; and
a thickness of the first edge portion increases gradually in a second direction from an edge of the each of the protrusions toward a centre of the each of the protrusions.

4. The liquid crystal display panel according to claim 3, wherein a thickness of the first middle portion is uniform in the second direction and is equal to a maximum thickness of the first edge portion.

5. The liquid crystal display panel according to claim 3, wherein the first edge portion comprises a first bottom sub-portion disposed on the base layer and a first transition sub-portion disposed on the first bottom sub-portion;
a thickness of the first transition sub-portion increases gradually in the second direction, and a thickness of the first bottom sub-portion is uniform in the second direction; and
the first transition sub-portion has a slope angle less than 90 degrees.

6. The liquid crystal display panel according to claim 3, wherein the first edge portion comprises a first bottom sub-portion disposed on the base layer and a first transition sub-portion disposed on the first bottom sub-portion;
each of the first transition sub-portion and the first bottom sub-portion has a thickness increasing gradually in the second direction; and
the first transition sub-portion and the first bottom sub-portion have a same slope angle less than 90 degrees.

7. The liquid crystal display panel according to claim 2, wherein the second edge portion comprises a second bottom sub-portion disposed on the insulating layer and a second transition sub-portion disposed on the second bottom sub-portion;
a thickness of the second transition sub-portion increases gradually in the first direction, and a thickness of the second bottom sub-portion is uniform in the first direction; and
the second transition sub-portion has a slope angle less than 90 degrees.

8. The liquid crystal display panel according to claim 2, wherein the second edge portion comprises a second bottom sub-portion disposed on the insulating layer and a second transition sub-portion disposed on the second bottom sub-portion;
each of the second transition sub-portion and the second bottom sub-portion has a thickness increasing gradually in the first direction; and
the second transition sub-portion and the second bottom sub-portion have a same slope angle less than 90 degrees.

9. The liquid crystal display panel according to claim 2, wherein a thickness of the second middle portion is uniform in the first direction and is equal to a maximum thickness of the second edge portion.

10. The liquid crystal display panel according to claim 9, wherein the orthographic projection of the first edge portion on the substrate at least partially overlaps the orthographic projection of the second edge portion of the one of the branch electrodes on the substrate; and
a thickness of the first edge portion increases gradually in a second direction from an edge of the each of the protrusions toward a centre of the each of the protrusions.

11. The liquid crystal display panel according to claim 10, wherein a thickness of the first middle portion is uniform in the second direction and is equal to a maximum thickness of the first edge portion.

12. The liquid crystal display panel according to claim 10, wherein the first edge portion comprises a first bottom sub-portion disposed on the base layer and a first transition sub-portion disposed on the first bottom sub-portion;
a thickness of the first transition sub-portion increases gradually in the second direction, and a thickness of the first bottom sub-portion is uniform in the second direction; and
the first transition sub-portion has a slope angle less than 90 degrees.

13. The liquid crystal display panel according to claim 10, wherein the first edge portion comprises a first bottom sub-portion disposed on the base layer and a first transition sub-portion disposed on the first bottom sub-portion;
each of the first transition sub-portion and the first bottom sub-portion has a thickness increasing gradually in the second direction; and
the first transition sub-portion and the first bottom sub-portion have a same slope angle less than 90 degrees.

14. The liquid crystal display panel according to claim 9, wherein the second edge portion comprises a second bottom sub-portion disposed on the insulating layer and a second transition sub-portion disposed on the second bottom sub-portion;
a thickness of the second transition sub-portion increases gradually in the first direction, and a thickness of the second bottom sub-portion is uniform in the first direction; and
the second transition sub-portion has a slope angle less than 90 degrees.

15. The liquid crystal display panel according to claim 9, wherein the second edge portion comprises a second bottom sub-portion disposed on the insulating layer and a second transition sub-portion disposed on the second bottom sub-portion;
each of the second transition sub-portion and the second bottom sub-portion has a thickness increasing gradually in the first direction; and
the second transition sub-portion and the second bottom sub-portion have a same slope angle less than 90 degrees.

16. The liquid crystal display panel according to claim 1, wherein a width of each of the branch electrodes is less than a width of each of the hollow portions, and is less than a width of each of the protrusions.

17. The liquid crystal display panel according to claim 1, wherein the first electrode layer comprises a pixel electrode, and the second electrode layer comprises a common electrode.

18. The liquid crystal display panel according to claim 1, wherein the first electrode layer comprises a common electrode, and the second electrode layer comprises a pixel electrode.

19. The liquid crystal display panel according to claim 1, wherein the array substrate further comprises a gate, an active layer, a source, a drain and a data line;
the insulating layer comprises a first insulating sublayer and a second insulating sublayer;
the gate is disposed on the substrate;
the first insulating sublayer covers the first electrode layer and the gate;
the active layer is disposed on the first insulating sublayer, and the source and the drain are respectively connected to two sides of the active layer;
the data line is disposed on the first insulating sublayer;
the second insulating sublayer covers the source, the drain and the data line;
the second electrode layer is disposed on the second insulating sublayer; and
the drain is connected to the first electrode layer.

20. The liquid crystal display panel according to claim 1, wherein the array substrate further comprises a gate, an active layer, a source, a drain and a data line;
the insulating layer comprises a first insulating sublayer and a second insulating sublayer;
the gate is disposed on the substrate;
the first insulating sublayer covers the first electrode layer and the gate;
the active layer is disposed on the first insulating sublayer, and the source and the drain are respectively connected to two sides of the active layer,
the data line is disposed on the first insulating sublayer,
the second insulating sublayer covers the source, the drain and the data line;
the second electrode layer is disposed on the second insulating sublayer; and
the drain is connected to the second electrode layer.
